(19) United States
(12) Patent Application Publication
(10) Pub. No.: US 2005/0077128 A1
(43) Pub. Date: Apr. 14, 2005

(54) Shock absorber module

(76) Inventors: Carl Vissers, Den Dungen (NL); Jacobus Zwarts, Nieuwegein (NL); Alexander Jan Carel De Vries, Tiel (NL); Hendrikus Jan Kapaan, Nieuwegein (NL)

Correspondence Address: Oliff & Berridge, PO Box 19928, Alexandria, VA, 22320, US

(21) Appl. No.: 10/474,271

(22) PCT Filed: Apr. 12, 2002
(86) PCT No.: PCT/NL02/00242

(30) Foreign Application Priority Data
Apr. 12, 2001 (NL) 1017842

(51) Int. Cl. F16F 9/12

(52) U.S. Cl. 188/266

(57) ABSTRACT

A schock absorber module comprises a shock absorber and a hub mounting, e.g. a mounting flange, connected thereto, said shock absorber having a cylindrical housing, carrying the hub mounting. The cylindrical housing and the hub mounting are formed as a single unit from sheet metal. Said cylindrical housing and the hub may be welded together, or be formed from one piece of sheet metal.

The invention is related to a shock absorber module comprising a shock absorber housing and a hub mounting, e.g. a mounting flange, connected thereto, said shock absorber housing being a cylindrical and carrying the hub mounting.

An example of a shock absorber is disclosed in EP-A-1043212. Said prior art shock absorber is an assembly comprising a number of components, such as a standard shock absorber and a tubular housing unit surrounding said shock absorber. The housing unit carries a steering knuckle, onto which the wheel bearing and the brake calliper are mounted.

The object of the invention is to provide a shock absorber module which is of a less complicated design and which has less separate components. This aim is achieved in that the cylindrical housing and the hub mounting are formed as a single unit from one piece of sheet metal.

The cylindrical housing and the hub mounting can be welded together. Alternatively, the cylindrical housing and the hub mounting can be formed from one piece of sheet metal.

The single piece of sheet metal from which the shock absorber module according to preferred embodiment of the invention is manufactured comprises a housing section which is bent into tubular shape, such that the edges of said housing section can be connected together by welding or cold forming.

The housing is transversely extended by means of a transverse arm which carries the hub mounting laterally with respect to the housing, said housing, transverse arm and hub mounting being formed as a single unit from one piece of sheet metal.

The transverse arm has integrated stiffening shapes, e.g. ribs and/or grooves. Said transverse arm gradually merges into the lower end of the housing by means of a transition piece, the shape of which is gradually changed from a tube form into a flat form.

The hub mounting comprises a flange provided with mounting means for mounting a hub bearing unit thereto. Said flange can be provided with mounting holes, and also with a central hole for accommodating the hub bearing unit.

Several variations are possible within the shock absorber module described before. For instance, the housing of the shock absorber may have at least two cylindrical sections of different diameters. Also, the shock absorber may have an end cap provided with an opening for guiding a linearly moving shaft. Furthermore, the sheet metal of the cylindrical housing can have a thickness which differs from the thickness of the sheet metal of the hub mounting. The metal of the cylindrical housing may be different from the metal of the hub mounting.

The hub mounting carries means for fixing a brake bracket or brake calliper thereto. The lower end of the cylindrical housing can be closed by means of a plug. Said plug carries a lever arm for connection to a torsion bar. The hub mounting carries fixation means for connecting a steering rod thereto.

The invention is furthermore related to a method of manufacturing the shock absorber module according to the invention. Said method comprises the steps of:
a) cold forming one piece of sheet metal to a round shape for the shock absorber section;
b) joining the ends of the round shape together by energy welding or cold forming;
c) cold and/or warm forming of the hub/flange section;
d) cold forming of bottom ball joint section or separate joining of a ball joint section by welding.

The piece of sheet metal may consist of a single unity, as of several parts welded together. Said parts may have the same of different thicknesses.

According to an alternative method, an extruded or weld tube section is partly cut open and flattened to form the sections for hub, flange and ball joint. Furthermore, it is not necessary to start off with a single piece of sheet metal. The method may therefore also comprise the step of joining of sheet metal parts by welding after which the above steps a, b, c, d are performed.

Also, a specific inner and/or outer surface finish for the tube section may be performed, e.g. in the case of applying a hydraulic shock absorber or of a sliding part of an electromechanical actuator.

The invention will now be described further with reference to an embodiment shown in the figures.

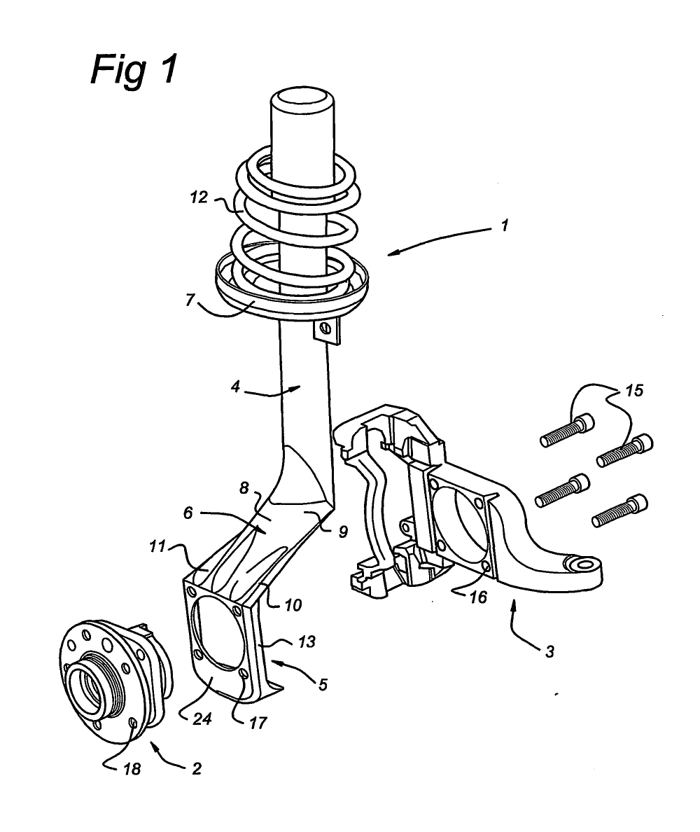

FIG. 1 shows an exploded view with the shock absorber module according to the invention.

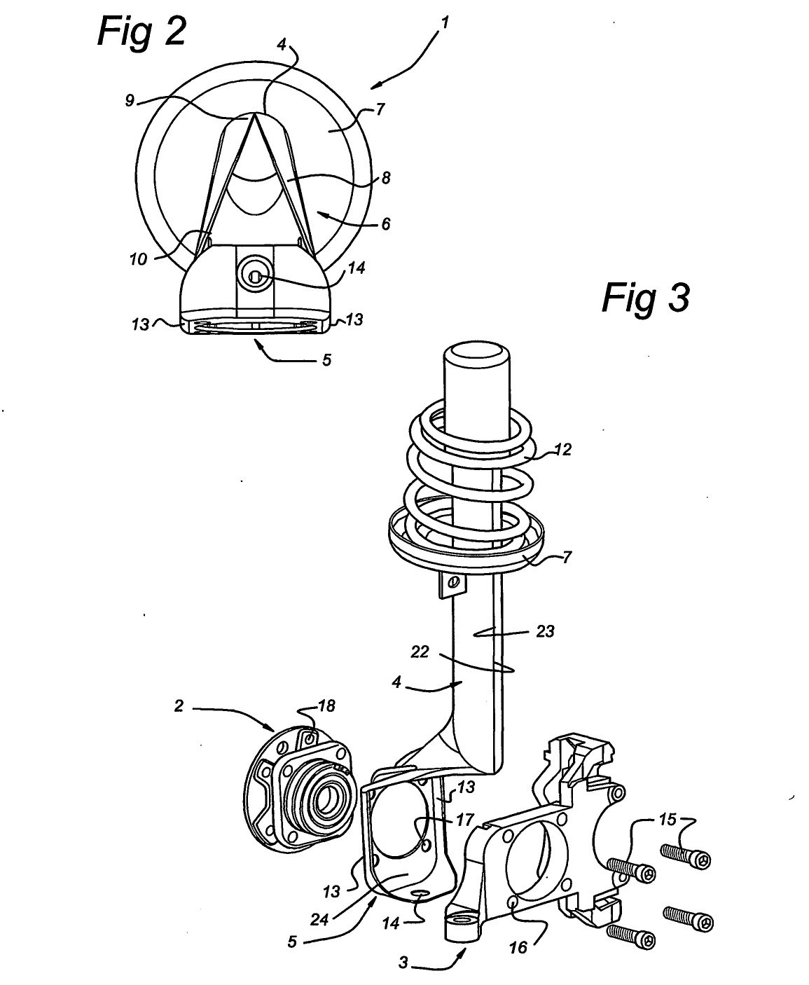

FIG. 2 shows a bottom view.

FIG. 3 shows an exploded view from a different view angle.

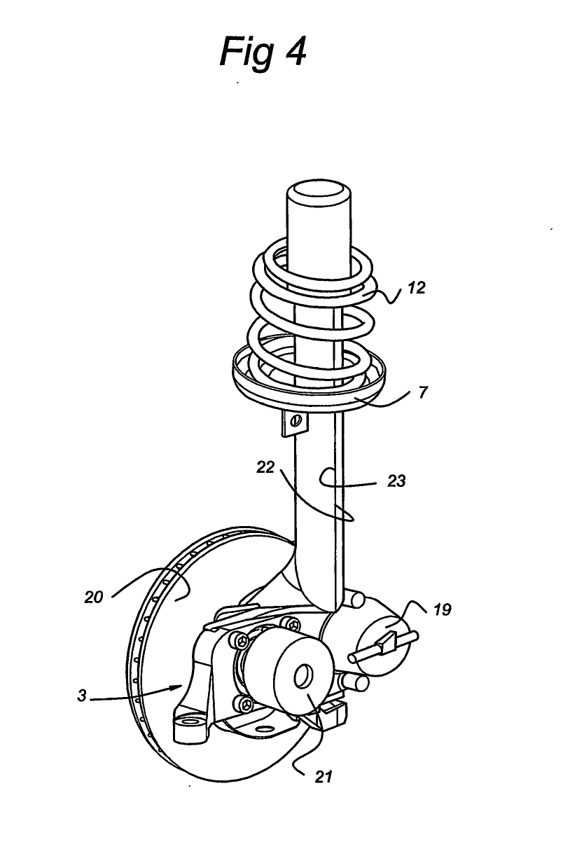

FIG. 4 shows an assembled unit.

FIG. 1 shows the shock absorber module 1 according to the invention, a hub bearing unit 2, as well as a calliper unit 3. The shock absorber module comprises a cylindrical housing 4, as well as a mounting flange 5. The mounting flange 5 is connected to the housing 4 by means of a transversely extending arm 6. The housing 4, the arm 6 and the mounting flange 5 form one unit from a single piece of sheet metal.

The bottom view of FIG. 2 shows that the transverse arm gradually merges into the lower end of the housing 4 by means of a transition piece 8, the shape of which is gradually changed from a tube form 9 into a flat form 10. Furthermore, stiffening ribs 11 have been integrated in the transverse arm 6 as well. Onto the housing 4, a support plate 7 has been welded onto which the spring 12 is supported.

As shown in FIG. 3, the mounting flange 24 has stiffening edges 13 which are bent over about 90°. At its lower end, the mounting flange is provided with a bottom ball joint means 14.

The shock absorber module 1 according to the invention can be assembled with the hub bearing unit 2 and the calliper means 3 in a simple and sturdy way by means of bolts 15, accommodated in corresponding holes 16, 17 and 18 in said components. The bolts 15 can be threaded in the screw threads provided in the holes 18.

The assembly shown in FIG. 4 has been equipped moreover with an electric brake actuator or hydraulic brake actuator 19, a brake disc 20 and a homokinetic coupling 21. The assembly can thus be mounted as a unit onto a vehicle carriage.

The cylindrical housing 4 is manufactured from a sheet housing section, which is bent into a cylindrical shape. The adjoining edges 22, 23 of said shape are welded together.

1. Shock absorber module (1), comprising a shock absorber having a cylindrical housing (4) within which a piston has been movably accommodated, and a hub mounting, e.g. a mounting flange (5), connected thereto, wherein the hub mounting (5) is carried by the cylindrical housing (4), characterized in that the cylindrical housing (4) and the hub mounting (5) are formed as a single unit from one piece of sheet metal.

2. Module according to claim 1, wherein the cylindrical housing (4) consists of a housing section of the one piece of sheet metal, said housing section being formed into a tubular shape and the longitudinal edges (22, 23) of said housing section being welded together.

3. Module according to claim 1, wherein the housing (4) is laterally extended by means of a transverse arm (6) which carries the hub mounting (5) transversely with respect to the housing (4), said housing (4), transverse arm (6) and hub mounting (5) being formed as a single unit from one piece of sheet metal.

4. Module according to claim 3, wherein the transverse arm has integrated stiffening shapes, e.g. ribs (11) and/or grooves.

5. Module according to claim 4, wherein the transverse arm (6) gradually merges into the lower end of the housing (4) by means of a transition piece (8), the shape of which is gradually changed from a tube form (9) into a flat form (10).

6. Module according to claim 1, wherein the hub mounting (5) comprises a flange (24) provided with mounting means (17) for mounting a hub bearing unit (2) thereto.

7. Module according to claim 6, wherein the flange (24) is provided with mounting holes (17).

8. Module according to claim 6, wherein the flange (24) is provided with an insert bearing housing, said housing being attached by welding or cold forming.

9. Module according to claim 7, wherein the flange (24) carries bottom ball joint means (14) at its lower end.

10. Module according to claim 7, wherein the flange (24) is provided with stiffening edges (13) which merge into the transverse arm (6).

11. Module according to claim 1, wherein the housing (4) of the shock absorber has at least two cylindrical sections of different diameters.

12. Module according to claim 1, wherein the shock absorber has an end cap provided with an opening for guiding a linearly moving shaft.

13. Module according to claim 1, wherein the sheet metal of the cylindrical housing (4) has a thickness which differs from the thickness of the sheet metal of the hub mounting (5).

14. Module according to claim 1, wherein the metal of the cylindrical housing (4) is different from the metal of the hub mounting (5).

15. Module according to claim 1, wherein the hub mounting (5) carries means (17) for fixing a brake bracket or brake calliper (3) thereto.

16. Module according to claim 1, wherein the cylindrical housing (4) is a part of a shock absorber, e.g. a hydraulic type, gas type and/or an electrical-mechanical type.

17. Module according to claim 1, wherein the lower end of the cylindrical housing (4) is closed by means of a plug.

18. Module according to claim 17, wherein the plug carries a lever arm for connection to a torsion bar.

19. Module according to claim 18, wherein the lever arm is of a hydraulic type or gas type.

20. Module according to claim 18, wherein the actuator is of an electromechanical type.

21. Module according to claim 1, wherein the hub mounting (5) carries fixation means for connecting a steering rod thereto.

22. Module according to claim 10 wherein the hub mounting (5) carries means (17) for fixing a brake bracket or brake calliper (3) thereto, and wherein the stiffening edges (13) engage a support beam which carries at least a brake bracket or brake calliper (3), a steering member or a bearing fixation means.

23. Module according to claim 1, wherein the cylindrical housing (4) and the hub mounting (5) are welded together.

24. Module according to claim 1, wherein the cylindrical housing (4) and the hub mounting (5) are formed from a single piece of sheet metal.

25. Unit for a shock absorber module according to claim 1, comprising a cylindrical shock absorber housing (4) and a hub mounting (5) which are formed from one piece of sheet metal.

26. Method for manufacturing a shock absorber module according to claim 1, comprising the steps of:
a) cold forming a piece of sheet metal to a round shape for the shock absorber section;
b) joining the ends of the round shape together by energy welding or cold forming;
c) cold and/or warm forming of the hub/flange section;
d) cold forming of bottom ball joint section or separate joining of a ball joint section by welding.

27. Method according to claim 26, comprising the step of using a piece of sheet metal consisting of welded parts of the same or different materials.
